(19) United States
(12) Patent Application Publication
(10) Pub. No.: US 2002/0079723 A1
(43) Pub. Date: Jun. 27, 2002

(54) Headrest retractor

(76) Inventors: Peter Risch, Mannheim (DE); Markus Kreisl, Roth (DE)

Correspondence Address: MACMILLAN, SOBANSKI & TODD, LLC, ONE MARITIME PLAZA-FOURTH FLOOR, 720 WATER STREET, TOLEDO, OH, 43604, US

(21) Appl. No.: 09/989,309

(22) Filed: Nov. 20, 2001

(30) Foreign Application Priority Data
Nov. 20, 2000 (DE) 10057447.5
Mar. 19, 2001 (DE) 10113233.6

(51) Int. Cl. B60N 2/48

(52) U.S. Cl. 297/61

(57) ABSTRACT

The invention relates to an actuating apparatus for a headrest, the holder of which is movably mounted in a receptacle within a vehicle seat back that can be folded down, with a traction device that acts on the holder and serves to pull the headrest back into a retracted position. Preferably, a headrest is attached to such a seat back by a mechanical actuating apparatus that is of simple construction and enables the headrest to be completely retracted from any pre-adjusted position when the seat back is folded down, and when the seat back is raised upright returns the headrest to the original, pre-adjusted position. This is achieved by an actuating apparatus for a headrest that is disposed in the region of the axis of rotation of the seat back; the retraction device of which comprises a Bowden cable the traction wire of which is attached at one end to the holder and at its other end to a reel plate, so that it can be unrolled and rolled up again; in which the seat back comprises a stopping or driving device that rotates together with the seat back and during its rotational movement permits or causes a rotation of the reel plate, as a result of which the traction wire is rolled up or unrolled; and in which the traction wire is under tension generated by an energy storage device connected to the holder.

### CROSS REFERENCE TO RELATED APPLICATIONS

This application claims priority to German Patent Applications Nos. 10057447.5 filed Nov. 20, 2000 and 10113233.6 filed Mar. 19, 2001.

### BACKGROUND OF THE INVENTION

Headrests of the kind concerned here are known in the state of the art and are employed in particular on the backs of seats in motor vehicles. The headrests have both a comfort function and a safety function, as they prevent the head from being thrown backwards in case of accidents. Ordinarily headrests are mounted on the seat back in such a way that their height is adjustable and they can be pivoted so as optimally to support the head of the seated person.

However, if the seat back needs to be folded down in order to load relatively large objects or to use its rear surface as a multifunctional storage area, possibly in combination with displacement of the seat as a whole, fully extended headrests often collide with the backs of the front seats or other structures in the restricted space of the vehicle interior. Hence before the seat back is folded down, it has so far been necessary to push the headrest by hand into a retracted position, in order to ensure that it is possible to fold the back of a seat down so that it is horizontal.

To solve this problem, electrical retraction and displacement means for headrests have so far been used, but these are correspondingly expensive and are mainly offered only in vehicles of the upper class. No particularly simple and economical equivalent employing an effective mechanical solution has previously been found.

### SUMMARY OF THE INVENTION

One of the advantages of the present invention is to provide a structurally simple mechanical actuating apparatus for a headrest mounted on a seat back that can be folded down, which completely retracts the headrest from its pre-adjusted position during the folding process and restores the headrest to the original position when the seat back is again raised upright.

This is achieved by an actuating apparatus for a headrest that is disposed in the region of the axis of rotation of the foldable seat back; the retraction device of which comprises a Bowden cable, with a traction wire that is attached at one end to the holder and at its other end to a reel plate, so that it can be unrolled and rolled up again; in which the foldable seat back comprises a stopping or driving device that rotates together with the seat back and during its rotational movement permits or initiates a rotation of the reel plate; and in which the traction wire is under tension generated by an energy storage device connected to the holder.

One point of the present invention is that when the seat is folded down by a suitable mechanism, energy for retracting the headrest is released from the storage device, and when the seat back is folded up, the energy is stored again. This is accomplished by releasing or pulling back a traction wire of a Bowden cable, which operates against the tractive or compressive force produced by an energy storage device. The storage device can take the form of a spring, or an element with a similar action, that is suitable for exerting an appropriate force on the holder of a headrest.

Preferably the movement of the holder of a headrest is controlled by an actuating apparatus disposed in the region of the axis of rotation of the seat back. As a result, the pivoting movement of the seatback is particularly simply converted into a rolling-up or unrolling movement to extend or shorten a free length of the traction device. The use of a Bowden cable as traction device allows the holder for the headrest to be situated in a place on the seat back that is spatially independent of the position of the actuating device, and furthermore the Bowden cable can be guided inside the seat back along its front or rear side, depending on the structural requirements.

The rolling-up and unrolling of the traction wire of the Bowden cable can be controlled in different ways, either by a stopping element that releases the reel plate so that it can rotate in the direction in which the traction wire is pulling, or else by a driving element that causes the reel plate to rotate against the pulling force of the traction wire.

Preferably the actuating apparatus is designed so that the energy storage device exerts a force on the holder that is directed towards the retracted position of the headrest, and the traction wire is guided around a deflection device in such a way that it counteracts this force. This construction ensures, in particular, that when the headrest has been completely retracted, the traction wire is no longer under tension, because at this point no tractive force is acting on it any longer.

Furthermore, in this case no restoring force is applied to the folded-over seat back by the actuating apparatus of the head rest, which would tend to bring it into the upright position. Alternatively, it is also possible to let the traction wire act directly on the holder of the headrest, without any deflection device.

Preferably the actuating apparatus is so designed that the energy storage device applies to the holder a force directed towards the retracted position of the headrest, and the Bowden cable is arranged so as to counteract this force. This arrangement eliminates a deflection roller and in particular if it is combined with a spiral spring disposed below the holder to serve as the energy storage device, the actuating apparatus can be constructed in an especially compact form, which furthermore—because additional structural components are eliminated—can be more economically manufactured.

However, the actuating apparatus can also preferably be so designed that the energy storage device applies to the holder a force directed towards an extended position of the headrest, and the traction wire counteracts this force. This kind of arrangement will, in particular, facilitate raising the seat back, because the force applied by the energy storage device is directed so as to assist this movement.

The structure of the actuating apparatus can be made especially simple and effective if the reel plate and the stopping or driving device are mounted on a common axle. This arrangement achieves an effective transfer of torque to the reel plate, in the case in which a driving device is provided, but also is fundamentally simple and favourable in construction.

This simple construction can be further improved by making the common axle identical to the axle about which the seat back rotates. The result, in particular, is that no additional components are needed to convert the rotational movement.

It is advantageous to provide an abutment for the Bowden cable that is mounted in a fixed position with respect to the chassis, on the same axis as the reel plate and the stopping or driving element. The result is that no additional structural features are required for the Bowden cable to be firmly mounted on the seat back.

If the abutment is constructed in an L shape so that it encloses the reel plate and has a bore on one side through which the traction wire passes, it is also possible for the traction wire to be guided to the reel plate in a simple manner.

This kind of structure functions with particular reliability when between the abutment and the reel plate a spacer disk is freely interposed, so that it prevents collision between the abutment and the stopping or driving element.

It is advantageous to ensure precise guidance of the traction wire around the circumference of the reel plate by an appropriately positioned groove. By this means, the wire is reliably prevented from sliding out of position or becoming jammed.

In an especially preferred arrangement, an actuating apparatus is constructed such that the reel plate has the form of a cylindrical segment or a cam, and on a first end face comprises an aperture in which to attach the Bowden cable. If the reel plate is constructed as a cam, with a suitable configuration of the diameter the release of the traction wire can be made variable, depending on the angle of rotation.

For example, it becomes possible for the headrest to be retracted to a great extent during the very first stage of folding the seat back down, by a special configuration of the reel plate in which the diameter is greatly decreased. It is very easy to produce this configuration, and it also simplifies replacement of the Bowden cble.

It is particularly advantageous for the actuating apparatus to be designed with a reel plate having a diameter such that the length of the cable that is unrolled and rolled up allows complete extension and retraction of the headrest between every preset position and the retracted position. By this means, extension and retraction of the headrest into and out of all other positions is also ensured.

The stopping or driving device of the actuating apparatus advantageously comprises a driving pin, which in at least one phase of folding down the seat back is in contact with a second end face of the reel plate. In the case of a stopping device, the driving pin is released from this second end face so that it allows the reel plate to rotate freely when the seat back is swivelled, permitting a length of wire to be unrolled under the pulling force of the traction wire. In the case of a driving device, the driving pin pushes the reel plate, by way of this second end face, against the pulling force of the traction wire, so that a length of wire is rolled up.

In an especially preferred design, an actuating apparatus for a retractable headrest is built into the seat of a vehicle. The advantages described here can be achieved in particular with a seat in the rear of the vehicle.

### BRIEF DESCRIPTION OF THE DRAWINGS

FIG. 1 shows a back of a rear seat of a motor vehicle, which can be folded down and into which are integrated two actuating apparatus in accordance with the invention, each for one headrest;

FIG. 2 is a perspective view of the actuating apparatus in accordance with the invention in a first position, when the seat back is completely upright;

FIG. 3 is a perspective view of the actuating apparatus in accordance with the invention in a second position, when the seat back is partially tilted forward;

FIG. 4 is a perspective view of the actuating apparatus in accordance with the invention in a third position, when the seat back is tilted further forward;

FIG. 5 is a perspective view of the actuating apparatus in accordance with the invention in a fourth position, when the seat back is folded all the way down;

FIG. 6 shows a functional principle of a retractable headrest;

FIG. 7a shows another functional principle of a retractable headrest, in the completely retracted state; and

FIG. 7b shows the functional principle of the retractable headrest according to FIG. 7a, in the extended state.

### DETAILED DESCRIPTION OF THE INVENTION

In the following description, the same reference numerals are used for identical parts or parts with identical actions.

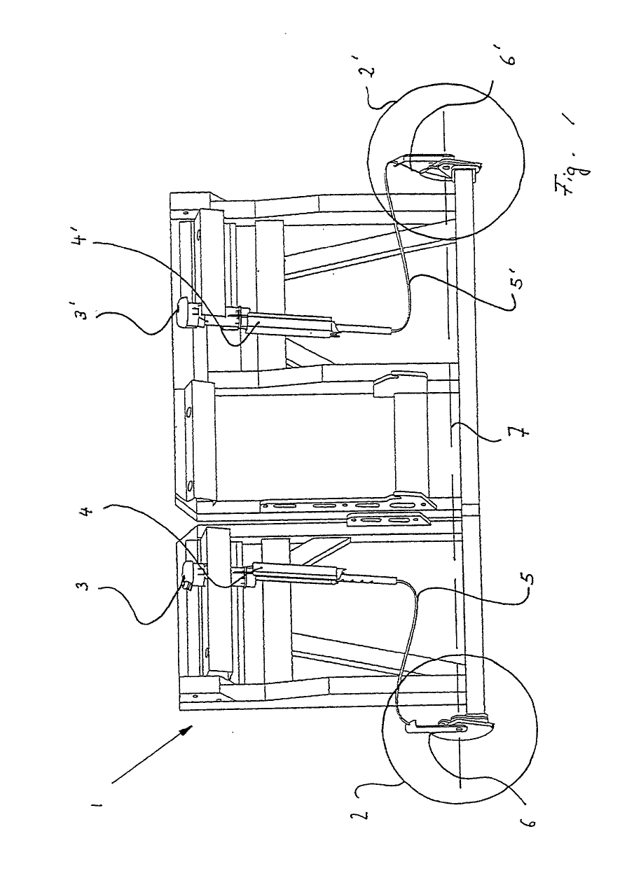

FIG. 1 shows in perspective a foldable backrest or back 1 of a rear seat of a motor vehicle; as is typical, the backs have a typical two-thirds division in their structure, and at the upper ends of the backs are receptacles to contain the holders of headrests. These holders are movably disposed at the upper end of the seat back 1. The receptacles 3, 3′ on one side of the holders of the headrests are especially clearly visible here; to them are attached an energy storage device, not visible here, and a deflection device 4, 4′. The energy storage device applies a tractive force to the holder of the associated headrest, which tends to pull the headrest into its retracted position.

At the lower end of the energy storage device and the deflection device is a traction device in the form of a Bowden cable 5, 5′, the lower end of which is connected to the actuating apparatus 2, 2′. The traction wire 6, 6′ of the Bowden cable 5, 5′ is likewise connected to the associated headrest holder and counteracts the pulling force of the energy storage device by way of the deflection device 4, 4′; that is, it tends to pull the headrest into an extended position.

Both the left and the right part of the seat back 1 can be individually tilted forward about an axis of rotation 7 at the lower end of the seat back 1. In the following, for the sake of brevity the term “fold down” the seat back will be used in this sense. The axis of rotation 7 is simultaneously the axis on which the actuating apparatus 2, 2′ is also mounted.

When the left part of the seat back 1 is folded down, towards the observer, the special mechanism in the actuating apparatus 2, 2′ releases the traction wire 6, 6′ of the Bowden cable 5, 5′ to move far enough that the holder of the headrest is pulled back towards its retracted position for precisely the same distance.

The largest possible length of travel of the traction wire 6, 6′, which is produced by folding the seat back 1 completely down in the direction of the observer, corresponds to the distance over which the headrest is retracted from a completely extended position into its retracted position.

The mechanism of the actuating apparatus 2, 2′ is so constructed that when the seat back 1 is folded down, towards the observer, the traction wire 6, 6′ is pulled out just far enough to move the headrest from an arbitrarily determined extended position into its retracted position.

When the seat back 1 is returned to its upright position, the mechanism of the actuating apparatus 2, 2′ ensures that the traction wire 6, 6′ is pulled back by exactly the length that had previously been released. As a result, the headrest is returned to the (upright) position to which it had previously been adjusted, against the tractive force exerted by the energy storage device, as the seat back 1 is raised.

The interaction between the actuating apparatus 2, 2′ and the energy storage device of the deflection device 4, 4′, by way of the Bowden cable 5, 5′, thus causes the headrest to be retracted from the position to which it had been adjusted into its retracted position when the seat back 1 is folded forwards, towards the observer, and when the seat back 1 is subsequently raised upright, the headrest is caused to be extended into the previously adjusted position.

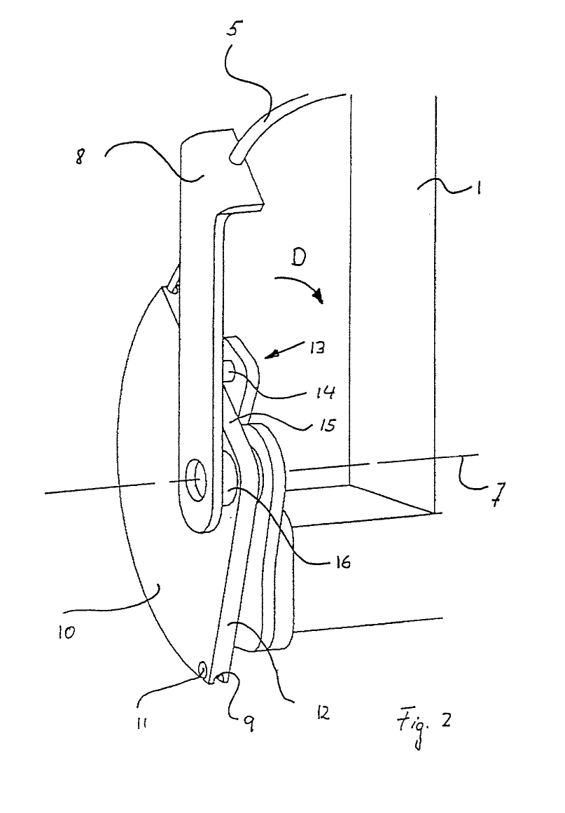

The following FIGS. 2 to 5 show perspective views of individual positions of the actuating apparatus 2, 2′ for a headrest while the seat back 1 is being folded down, to assist a more detailed explanation of the functional principle of the actuating apparatus 2, 2′.

A feature shown particularly clearly here is an abutment 8 fixed to the chassis to which the lower end of the Bowden cable is attached. The traction wire 6 of the Bowden cable 5 is guided through a bore on the short side of the abutment 8 and then runs within a groove 9 along the circumference of a reel plate 10, with which it is ultimately connected at a first end face 12 by means of an aperture 11.

The reel plate 10 is rotatably mounted on the axle 7 and is affected by the pulling force exerted by the traction wire 6. When the seat back is in the first position, as shown in FIG. 2, the reel plate is braced against a stopping device 13 that is firmly fixed to the seat back 1. The stopping device 13 comprises a driving pin 14, which when the seat back 1 is folded down, in the direction towards the observer, allows the reel plate 10 to rotate in the direction in which it is being is pulled by the traction wire 6.

Therefore a length of the traction wire 6 corresponding to the rotation of the reel plate 10 is released. This release of the wire causes the holder of the headrest to move over the same distance in the direction of the tractive force applied by the energy storage device, so that it is pulled in towards the retracted position of the headrest.

When the headrest has reached its retracted position, a tractive force is no longer applied to the traction wire 6, and hence also not to the reel plate 10, so that the reel plate 10 stops rotating. Until this point a second end face 15 of the reel plate 10 has been constantly in contact with the driving pin 14 of the stopping device 13.

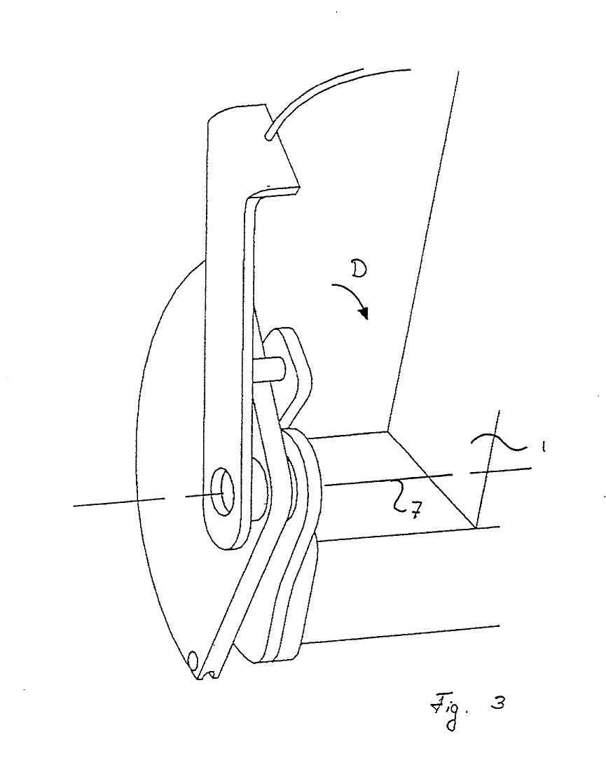

FIG. 3 shows the actuating apparatus 2 in a second position, such that the seat back 1 has been partially folded down towards the observer; here the stopping device 13 has allowed the reel plate 10 to rotate and hence to release another segment of the length of the traction wire 6. In this position the headrest has been pulled back towards its retracted position by an amount corresponding to the rotation of the seat back 1.

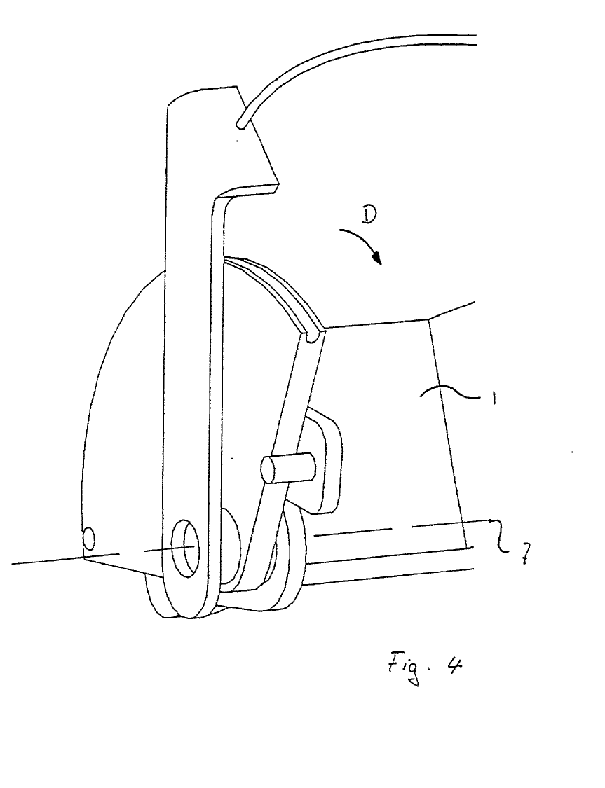

FIG. 4 shows the actuating apparatus 2 in a third position, with the seat back 1 folded still further down towards the observer. Now the stopping device 13 has allowed the reel plate 10 to rotate further under the force imposed by the traction wire 6, so that an additional segment of the wire 6 has been freed and the headrest could be drawn towards its retracted position by this additional amount.

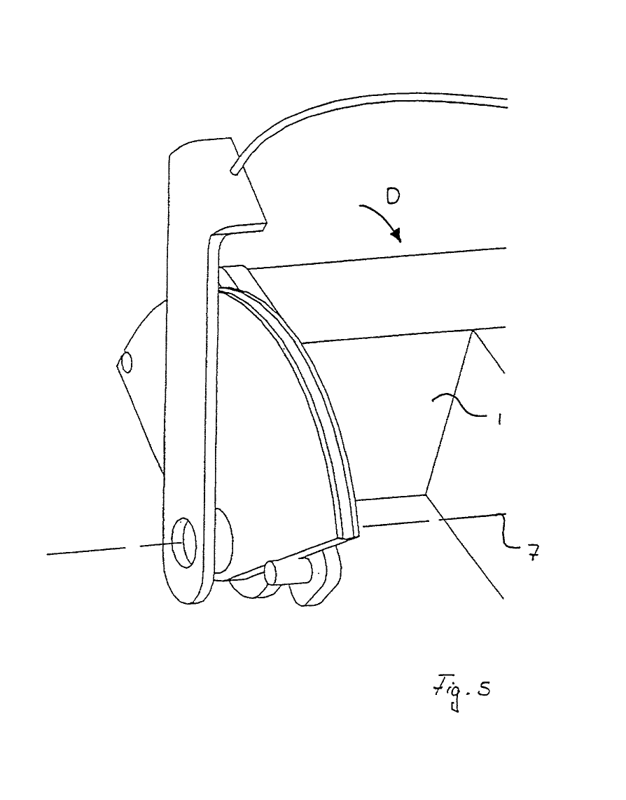

FIG. 5 shows the actuating apparatus 2 in a fourth position, in which the seat back 1 has been folded all the way down towards the observer and the headrest is fully retracted. When the actuating apparatus 2 is in this position, no more tractive force is acting on the traction wire 6.

Because of its simple construction, all the components of the actuating apparatus 2 can be mounted on the axle 7 of the seat back 1; a spacer disk is interposed between the abutment 8, which is fixed to the chassis, and the reel plate 10, to prevent a collision between the driving pin 13 of the stopping device 12 and the abutment 8. The direction of rotation of the seat back 1 is indicated by the arrow D.

When the seat back 1 is returned to its upright state, the elements shown in FIGS. 2 to 5 change their positions in the reverse order, so that the length of the traction wire 6 of the Bowden cable 5 that had initially been freed or released is drawn in again, and the headrest is pulled back into its original, previously adjusted position against the tractive force exerted by the energy storage device.

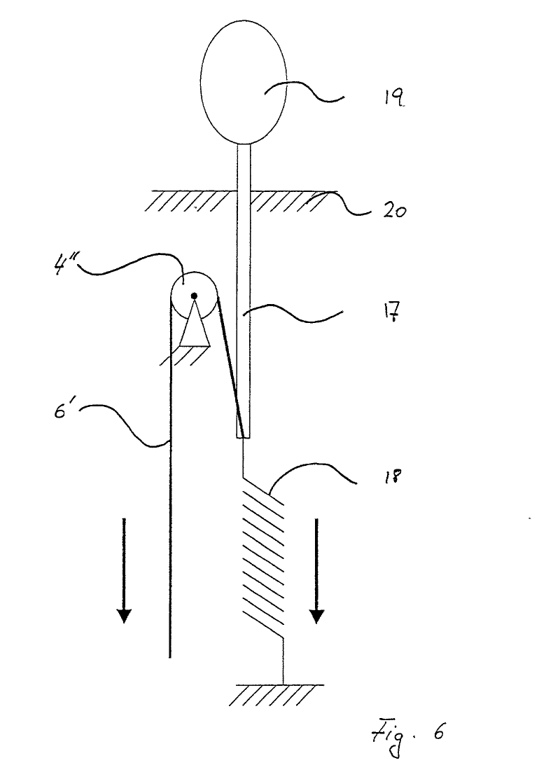

FIG. 6 illustrates a functional principle of a retractable headrest 3. It shows a traction wire 6′, which comes from the actuating apparatus 2 and passes over a redirecting device 4″ on its way towards the lower end of a holder 17. The traction wire 6′ is firmly connected to the holder 17 at the lower end of the latter, as also is an energy storage device in the form of a spring 18. The lower end of the spring 18 is firmly fixed to the seat back.

At the upper end of the holder 17 a headrest 19 is indicated; it can move vertically through a receptacle 3″ that is integrated into the seat back. The spring 18 applies a downwards directed pulling force to the holder 17 of the headrest 19, which simultaneously acts on the traction wire 6′.

Against the pulling force of the spring 18, the holder 17 of the headrest 19 is kept in position by the traction wire 6′.

But if a length of the traction wire 6′ is released, the spring 18 pulls the holder 17 of the headrest 19 into the seat back by exactly the same distance. The release of a length of traction wire 6′ is brought about when the back of a seat is folded down, by the function of the actuating apparatus 2 described above.

In every case the headrest 19 is pulled inward until it is against the upper end of the seat back. The excursion of the spring is chosen to be long enough that the headrest 19 can be completely retracted into the seat back even when starting from a maximally extended position. Hence this functional principle guarantees that the headrest 19 will also be fully retracted when starting from any intermediate preset position.

As the seat back is being returned to the upright state, so that a length of the tension wire 6′ is rolled up by means of the actuating apparatus 2, the holder 17 of the headrest 19 is pulled upward into its original position, against the tractive force of the spring 18. Hence when the seat back is upright, the headrest 19 has reached the position to which it had originally been adjusted.

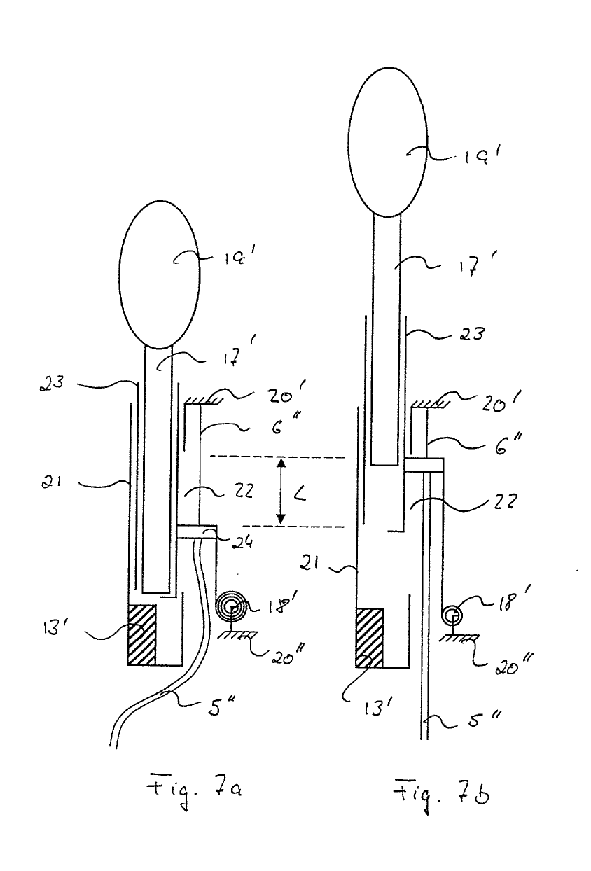

FIG. 7a illustrates another functional principle of a retractable headrest 19′, which is attached to a holder 17′ and thereby supported within a guide means 23. By pulling the holder 17′ out of the guide means 23, the user can position the headrest 19′ as desired and lock it into place, for instance by means of adjustment elements. In this process the holder 17′ is moved relative to the guide means 23, both of which structures in turn are mounted together within a sleeve 21 containing a stopping device 13′.

When the guide means 23 is fully retracted into the sleeve 21, as shown here, and the seat back is folded down out of an upright position, a length L of a traction wire 6″ is released. In this case the lug 24, which is fixedly attached to the guide means 23 and can move within an opening 22, is pulled towards the stopping device 13′ according to the force exerted by a spiral spring 18′ and against the force of the Bowden cable 5″. The holder 17′, with the headrest 19′ attached to its upper end, as shown here is locked into a retracted position within the guide means 23.

The traction wire 6″ is attached by its upper end to a bearing surface 20′ that is firmly connected to the seat back. The spiral spring 18′ is connected at one side to a bearing surface 20″ that is firmly connected to the seat back, and at the other side to the lug 24.

The state shown here, with a completely retracted headrest 19′, corresponds to the state of the headrest 19′ when the seat back is folded down. As mentioned above, during this movement of the seat back the traction wire 6″ is released by an amount such that the total length of the traction wire 6″ between the actuating apparatus 2, 2′ and the upper fixation point of the traction wire 6″, namely the bearing surface 20′, is extended by the length L. However, there is no change in the length of the Bowden cable 5″ between the abutment 8 and the lug 24.

When the length of the traction wire 6″ is increased, therefore, the Bowden cable 5″ is pressed downward by the lug 24, under the action of the spring force of the spiral spring 18′, and because the distance between lug 24 and abutment 8 is reduced, the cable becomes curved. This movement is continued until the guide means 23 and hence the holder 17′ of the headrest 19′ reaches the stopping device 13′.

It is evident in the figure that this embodiment, by eliminating a redirecting device 4, 4′ such as is shown in FIG. 6 and by making it particularly easy to integrate the spiral spring 18′ that stores the energy, can be constructed in an especially simple and compact form. It is particularly advantageous here that the spiral spring is disposed in the region of the stopping device 13′ of the sleeve 21.

FIG. 7b is another drawing of the retractable headrest according to FIG. 7a, but here in the state in which the seat back is vertical and, accordingly, the headrest 19′ has been returned to its extended position. In this drawing, furthermore, the user has pulled the headrest 19′ on its holder 17′ out of the guide means 23 and repositioned it as desired.

The length L of the traction wire 6 ″ has now been rolled back onto the reel plate 10, so that the lug 24 has moved upwards under the pressure of the Bowden cable 5″, which has now become straight again, and against the force exerted by the spiral spring 18′. Therefore the guide means 23 has also moved upwards, together with the holder 17′ it contains and the headrest 19′.

The extent to which the guide means 23 can move within the sleeve 21 as the seat back is folded down is always sufficient to retract the headrest 19′ out of an arbitrarily pre-adjusted position as far as the stopping device 13′, and also to return it to a height originally chosen by the user when the seat back is subsequently raised to its vertical position.

At this juncture it should be pointed out that all the parts described above both individually and in combination, in particular the details shown in the drawings, are claimed as essential to the invention. Modifications thereof are familiar to a person skilled in the art.

In accordance with the provisions of the patent statutes, the principle and mode of operation of this invention have been explained and illustrated in its preferred embodiment.

However, it must be understood that this invention may be practiced otherwise than as a specifically explained and illustrated without departing from its spirit or scope.

What is claimed is:

1. Actuating apparatus for a headrest the holder of which is movably mounted in a receptacle within a vehicle seat back that can be folded down, comprising a traction device that acts on the holder and serves to pull the headrest into a retracted position, wherein
the actuating apparatus is disposed in the region of the axis of rotation of the seat back;
the traction device comprises a Bowden cable the traction wire of which is connected at one end to the holder and at its other end to a reel plate onto which it can be rolled up, or from which it can be unrolled;
the seat back comprises a stopping or driving device that rotates together with the seat back and during this rotational movement permits or drives a rotation of the reel plate, so that the traction wire is rolled up or unrolled; and
the traction wire is placed under a tractive force generated by an energy storage device that is connected to the holder.

2. Apparatus according to claim 1, wherein the energy storage device applies to the holder a force directed towards the retracted position of the headrest and the traction wire is guided, in particular by way of a deflection device, in such a way that it counteracts this force.

3. Apparatus according to claim 1, wherein the energy storage device applies to the holder a force directed towards the retracted position of the headrest and the Bowden cable is guided in such a way that it counteracts this force.

4. Apparatus according to claim 1, wherein the energy storage device is constructed as a tension spring, in particular a spiral spring.

5. Apparatus according to claim 1, wherein the energy storage device applies to the holder a force directed towards an extended position of the headrest, and the traction wire counteracts this force.

6. Apparatus according to claim 1, wherein the reel plate and the stopping or driving device are mounted on a common axle.

7. Apparatus according to claim 6, wherein the common axle coincides with the axis of rotation of the seat back.

8. Apparatus according to claim 1, wherein an abutment for the Bowden cable is mounted in a fixed position with respect to the chassis on the same axle on which the reel plate and the stopping device or driving pin are mounted.

9. Apparatus according to claim 8, wherein the abutment has the shape of an L, at one side of which is disposed a bore through which the traction wire passes, and which encompasses the reel plate.

10. Apparatus according to claim 8, wherein between the abutment and the reel plate there is disposed a freely mounted spacer disk, which prevents collision between the abutment and the stopping or driving device.

11. Apparatus according to claim 1, wherein the reel plate comprises a groove formed at its periphery, within which the traction wire is guided.

12. Apparatus according to claim 1, wherein the reel plate is constructed as a segment of a cylinder or a cam plate and at a first end face comprises an aperture for attachment of the Bowden cable.

13. Apparatus according to claim 1, wherein the reel plate has a diameter so dimensioned that the length of the Bowden cable that is unrolled or rolled up is such as to enable complete retraction and extension of the headrest between any pre-adjusted extended position and the fully retracted position.

14. Apparatus according to claim 1, wherein the stopping or driving device comprises a driving pin that is in contact with a second end face of the reel plate during at least one phase of folding down the seat back.

15. Apparatus according to claim 1 further including a vehicle seat, wherein the actuating apparatus is mounted thereon.

16. Apparatus according to claim 15, wherein the vehicle seat is a rear seat of a vehicle.
